(19) United States
(12) Patent Application Publication
(10) Pub. No.: US 2025/0118908 A1
(43) Pub. Date: Apr. 10, 2025

(54) LEAD TERMINAL FOR CONNECTING AN ELECTRICAL CONDUCTOR

(71) Applicant: WAGO Verwaltungsgesellschaft mbH, Minden (DE)

(72) Inventors: Silvio LOBING, Leinefelde-Worbis (DE); Klaus HALBFAS, Hildesheim (DE); Max BOETTCHER, Eberleben (DE)

(73) Assignee: WAGO Verwaltungsgesellschaft mbH, Minden (DE)

(21) Appl. No.: 18/905,053

(22) Filed: Oct. 2, 2024

(30) Foreign Application Priority Data
Oct. 4, 2023 (DE) 20 2023 105 738.1

(51) Int. Cl. H01R 4/2433

(52) U.S. Cl. CPC H01R 4/2433

(57) ABSTRACT

A lead terminal for connecting an electrical conductor, having an electrically conductive core and insulation sheathing that encloses the electrically conductive core, and including a housing and at least one insulation displacement contact at which the electrical conductor is electrically contactable, without previously stripping the insulation sheathing, by use of an insulation displacement operation in which the insulation sheathing is partially cut open. At least one swivelably supported actuating element is also provided. The electrical conductor is electrically contactable at the at least one insulation displacement contact when the actuating element is manually actuated. The housing may be designed as an insulation material housing, for example.

This nonprovisional application claims priority under 35 U.S.C. § 119 (a) to German Patent Application No. 20 2023 105 738.1, which was filed in Germany on Oct. 4, 2023, and which is herein incorporated by reference.

### BACKGROUND OF THE INVENTION

### Field of the Invention

The invention relates to a lead terminal for connecting an electrical conductor, having an electrically conductive core and insulation sheathing that encloses the electrically conductive core, and including a housing and at least one insulation displacement contact at which the electrical conductor is electrically contactable, without previously stripping the insulation sheathing, by use of an insulation displacement operation in which the insulation sheathing is partially cut open, and including at least one swivelably supported actuating element, the electrical conductor being electrically contactable at the at least one insulation displacement contact when the actuating element is manually actuated. The housing may be designed as an insulation material housing, for example.

### Description of the Background Art

Such a lead terminal is known, for example, from DE 29 02 536 C2, which corresponds to U.S. Pat. No. 4,340,270.

### SUMMARY OF THE INVENTION

It is therefore an object of the invention to further improve such a lead terminal.

In an example, the lead terminal can have its own manual actuating element. By use of such a manual actuating element, the lead terminal may be handled completely or at least for the most part without a tool. In particular, no external tool is necessary for connecting the electrical conductor via the insulation displacement operation, since this can take place using the manual actuating element.

With such a lead terminal, the electrical conductor may be easily and quickly connected to the lead terminal without special preparation, for example wire stripping and/or crimping, and in particular also without a separate actuating tool.

Such an insulation displacement contact is also referred to as an IDC.

Via a swivel operation, the actuating element may be moved in particular from an unactuated position, in which the electrical conductor may be inserted into or removed from the lead terminal and is not connected to the insulation displacement contact, into an actuated position in which the electrical conductor is connected to the insulation displacement contact. The actuating element may also be moved back from the actuated position into the unactuated position via an opposite swivel operation.

According to an example, the actuating element can be fixable to a component of the lead terminal, for example to the housing of the lead terminal, at least in an actuated position in which the electrical conductor is connected to the insulation displacement contact, the lead terminal having at least one unlocking element via which the fixing of the actuating element in the actuated position may be released. The actuating element is thus secured in the actuated position, so that at the same time, it is ensured that the electrical conductor that is connected to the insulation displacement contact also remains there and cannot be unintentionally disconnected. A high level of contact reliability is thus ensured.

By use of the unlocking element, the fixing of the actuating element may be released, for example by simple manual actuation of the unlocking element, so that the actuating element is once again freely movable between the actuated and the unactuated position. The actuating element may then be moved, for example, back into the unactuated position, so that the connected electrical conductor may once again be removed from the insulation displacement contact by use of the actuating element, so that the electrical conductor may then be removed from the lead terminal. In addition, the lead terminal may be handled completely or at least for the most part without a tool, in particular an external tool.

For example, the actuating element may be lockable in the actuated position, for example at the housing of the lead terminal. This locking may be released by means of the unlocking element.

According to an example, at least one contact protection tab can be provided at the actuating element, via which an electrically conductive contact insert situated in the housing of the lead terminal and/or the at least one insulation displacement contact are/is covered in the actuated and/or unactuated position of the manual actuating element and consequently shielded from the external environment. A high level of contact protection is thus achieved for the lead terminal, using simple means. Current-carrying components inside the housing of the lead terminal are thus protected from unintentional access from the outside. The at least one contact protection tab may be fastened to the actuating element or formed in one piece with the actuating element, for example in the form of an injection-molded part.

According to an example, the lead terminal can have at least one display element, via which a sufficient actuation of the actuating element into the actuated position, in which the electrical conductor is connected to at least one insulation displacement contact, is displayable. This allows simple, quick checking of the correct contacting of the electrical conductor. The user can thus easily recognize whether the manual actuating element has been moved far enough in the direction of the actuated position.

The display element may in particular be designed as an optical display element, for example as an optical fiber, light-conducting shaft, or some other light-emitting component.

The display element can be designed as a purely mechanical component that is movable by means of the manual actuating element. This has the advantage that the display element does not require an electrical power supply. In addition, the display element may be implemented relatively easily and inexpensively, for example as part of a contact protection tab of the actuating element. For example, the free end of such a protection tab may form the display element.

The housing of the lead terminal may have a receiving channel for accommodating the at least one contact protection tab. The at least one contact protection tab is then guided in this receiving channel. Since the actuating element is swivelably supported, during manual actuation it carries out a swivel movement. The receiving channel for the at least one contact protection tab may accordingly be designed as a curved receiving channel that has a radius of curvature corresponding to the swivel movement of the actuating element.

The at least one contact protection tab may be designed as a curved contact protection tab. The curvature of the at least one contact protection tab may extend concentrically with respect to the rotational axis of the actuating element.

The at least one insulation displacement contact may be designed as a movable insulation displacement contact, for example in such a way that the at least one insulation displacement contact is movable in the housing by means of the actuating element in order to press the insulation displacement contact against the electrical conductor.

The at least one insulation displacement contact can be fixed relative to the housing of the lead terminal. In this way, a contact insert situated in the housing of the lead terminal may have a particularly simple and robust design, for example as a stamped/bent part that includes the at least one insulation displacement contact or multiple insulation displacement contacts.

The actuating element can be designed as a swivelable actuating lever that is swivelable about a stationary or mobile rotational axis. This allows the lead terminal to be easily actuated with a moderate manual actuating force. In the case of a mobile rotational axis, the actuating lever may be float-mounted, for example.

The actuating element can have an actuating arm that protrudes from the housing of the lead terminal, via which the actuating element can be manually movable into the actuated position without a tool. This allows simple ergonomic actuation of the lead terminal by the user. The actuating forces may be minimized by providing an appropriate length of the actuating arm.

A contact protection tab can be situated at the actuating element, on one side or on each of two sides facing away from one another, in particular by forming it as one piece with the actuating element. This allows a particularly high level of contact protection for the lead terminal, in particular in all actuating positions of the actuating element.

In the case of contact protection tabs at two sides of the actuating element facing away from one another, an electrically conductive contact insert situated in the housing of the lead terminal and/or the at least one insulation displacement contact may be covered by one contact protection tab in the actuated position of the manual actuating element, and may be covered by the other contact protection tab in the unactuated position of the manual actuating element.

The at least one insulation displacement contact can have at least two legs, between which a V-shaped cutting slot is provided, in particular with mutually opposite cutting edges. The electrical conductor may then be accommodated by clamping it between the at least two legs. This allows reliable wire stripping and subsequent clamping of the electrical conductor. For example, the at least two legs in the area of their free ends may have leading cutting edges for carrying out the wire stripping operation, i.e., for cutting into the insulation sheathing. A clamping section for clamping the electrically conductive core, having a less sharp-edged design than the cutting edges, may adjoin the cutting edges.

The at least one unlocking element can be situated on a side of the actuating element facing away from the insulation displacement contact. This allows simple, intuitive manual actuation of the lead terminal for unlocking the actuating element.

For example, the fixing of the actuating element in the actuated position may take place by locking at least one contact protection tab at the housing. The unlocking by the unlocking element may occur by pressing the unlocking element against the contact protection tab in the manner of a push element and thus guiding the contact protection tab out of the locked position, for example by elastic deformation of the contact protection tab.

The at least one unlocking element can be situated in an unlocking shaft of the housing. This allows reliable placement of the unlocking element that is achievable with a simple design. In addition, the unlocking element may be held in the unlocking shaft in a form-fit manner so that it does not fall out of the housing.

The actuating element can have a hollow channel through which the electrical conductor, at least in the unactuated position of the actuating element, is insertable into the housing of the lead terminal. In this way the lead terminal may have a particularly compact design, since no separate conductor insertion opening for the electrical conductor is necessary. Instead, the actuating element may contain this conductor insertion opening through the hollow channel. The hollow channel may be surrounded by walls that are part of the actuating element.

A pressing surface can be provided at the actuating element, via which the electrical conductor is pressable against the at least one insulation displacement contact and electrically contactable thereto when the actuating element is manually actuated into the actuated position. Secure contacting of the electrical conductor at the insulation displacement contact is ensured in this way, and the functional reliability of the lead terminal is thus further improved.

The pressing surface can be provided at an inner side of a wall of the actuating element that surrounds the hollow channel. The actuating element is thus designed as a multifunctional component of the lead terminal that includes functions for clamping the electrical conductor and also for releasing the electrical conductor from the insulation displacement contact.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a lead terminal in a perspective view,

FIG. 2 shows an insulation displacement contact and an electrical conductor,

FIG. 3 shows an actuating element of the lead terminal according to FIG. 1, and

FIG. 4 shows a side sectional view of the lead terminal according to FIG. 1.

### DETAILED DESCRIPTION

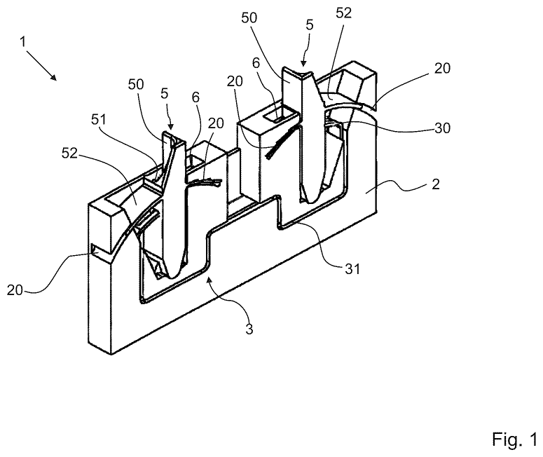

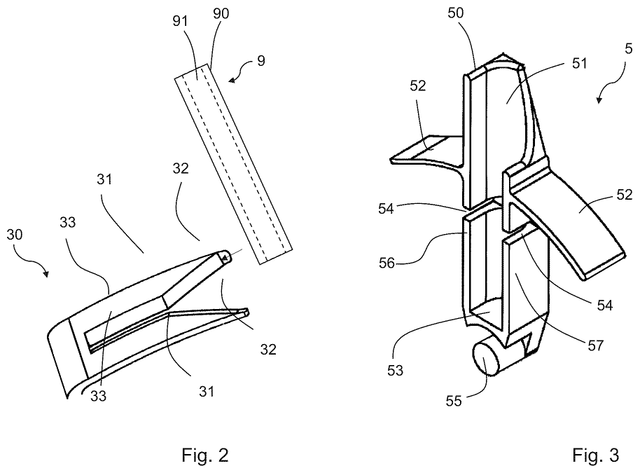

A lead terminal 1 designed as a terminal block, for example, and including a housing 2 is apparent in FIG. 1. A contact insert 3, which in this example has two insulation displacement contacts 30, is situated in the housing 2. The insulation displacement contacts 30 are connected to one another via an electrically conductive connection 31, for example a busbar. The insulation displacement contacts 30 are each used to connect an electrical conductor 9 (illustrated in FIG. 2), which has an electrically conductive core 91 and insulation sheathing 90 that encloses the electrically conductive core 91.

It is also apparent in FIG. 1 that the lead terminal 1 for each insulation displacement contact 30 has a pivotably supported actuating element 5 that is associated with the insulation displacement contact 30. The actuating element 5 in each case has an actuating arm 50 that protrudes from the housing 2, similarly to a lever arm, that is used to manually actuate the actuating element 5. The actuating arm 50 is adjoined by a hollow channel 51 of the actuating element 5, through which the electrical conductor 9 is insertable into the housing 2. In addition, at least one contact protection tab 52 is situated at the actuating element 5, in the example the actuating element 5 having a contact protection tab 52 on each of two sides that face away from one another. The contact protection tabs 52 have a curved design to allow them to concentrically follow the swivel movement of the actuating element 5. Receiving channels 20 that are used to accommodate and guide the particular contact protection tab 52 are provided in the housing 2.

It is also apparent that an unlocking element 6, associated with each actuating element 5, is situated in the housing 2. The function of the unlocking element is described in greater detail below.

FIG. 2 illustrates an example of an insulation displacement contact 30. The insulation displacement contact 30 has at least two legs 31, between which a V-shaped cutting slot is provided. A cutting edge 32 is present at each leg 31 in the area of the V-shaped cutting slot. In the further course of inserting the electrical conductor, behind the cutting edges 32 clamping sections 33 are situated at the respective leg 31, at which the electrical conductor 9 or its electrically conductive core 91 is ultimately clamped. The cutting edges 32 are used to cut into the insulation sheathing 90.

FIG. 3 shows an example of an actuating element 5, in particular in the form of a swivelably supported actuating lever, with further details. The hollow channel 51 used to insert the electrical conductor 9 is apparent. The hollow channel 51 ends at a conductor stop 53 that delimits the maximum insertion depth of the electrical conductor 9. In the hollow channel 51, it is clear that prior to the conductor stop 53, openings 54 are provided in the walls surrounding the hollow channel 51 and are used to guide the respective insulation displacement contact 30 through. It is also apparent that the contact protection tabs 52 may be formed in one piece with the actuating element 5.

The hollow channel 51 may be surrounded, for example, by three walls of the actuating element 5 and by an inner surface of a wall of the housing 2, so that the hollow channel is surrounded at four sides of the walls (see FIG. 1).

The actuating arm 50 may be formed by a wall which surrounds the hollow channel, and which protrudes farther from the housing 2 than the wall of the hollow channel 51 opposite from the actuating arm 50. A passage for an electrical conductor that is situated at an angle outside the housing 2 is thus created.

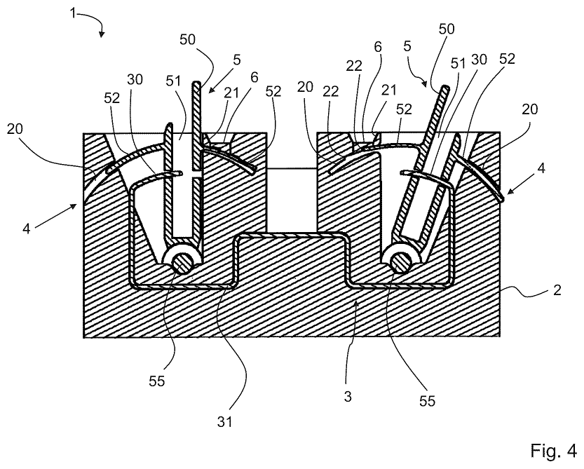

A wall that surrounds the hollow channel 51 may include a pressing surface 56 for pressing the electrical conductor against the insulation displacement contact 30; i.e., when the actuating element 5 is moved from an unactuated position, as illustrated in FIG. 1, into an actuated position as illustrated in the right portion of FIG. 4, the electrical conductor 9 is pressed into the cutting slot by means of the pressing surface 56. On the side opposite from the pressing surface 56, at an inner side of a wall that surrounds the hollow channel 51 a release surface 57 may be provided, via which the electrical conductor is released from the insulation displacement contact 30 when the actuating element 5 moves from the actuated position into the unactuated position.

In addition, the actuating lever 5 may have a bearing axis 55 which at the same time forms a rotational axis of the actuating element 5 during the swiveling. The bearing axis 55 may be accommodated, for example, in a corresponding receptacle in the housing 2.

FIG. 4 shows the lead terminal 1 in a state in which the actuating element 50 illustrated on the left is in the unactuated position, in which an electrical conductor may be inserted into or removed from the hollow channel 51. The actuating element 50 illustrated on the right is in the actuated position, in which an electrical conductor may be connected to the insulation displacement contact 30. In this state, the electrical conductor cannot be removed from the hollow channel 51.

As is also apparent in FIG. 4, the free end of a contact protection tab 52, optionally together with the receiving channel 20 of the housing 2, forms a display element 4 via which an adequate actuation of the manual actuating element 5 into the actuated position, in which the electrical conductor 9 is connected to the insulation displacement contact 30, is visually displayed to the user. For the actuating element 5 illustrated on the right, the free end of the contact protection tab 52 protrudes slightly from the housing 2 or the receiving channel 20. In the unactuated position, apparent at the left, a free end of the contact protection tab 52 does not protrude from the receiving channel 20. Visual assistance may be provided by different coloring of the contact protection tab 52 and the housing 2.

Also apparent in FIG. 4 is the fixing of the actuating element 5 in the actuated position, for example by locking a contact protection tab 52 in the receiving channel 20 at a locking edge 22. Multiple locking edges 22 in succession may be present in the receiving channel 20, so that the actuating element 5 may be lockable in various positions, and thus secured against movement into the unactuated position.

Situated in an unlocking shaft 21 of the housing 2 is an unlocking element 6 which is associated with each contact protection tab 52, and which may be designed in the manner of a push element, for example. By actuating an unlocking element 6, for example by applying a pressure force to the unlocking element 6, the actuating element 5 in a locked position may be released, for example by the unlocking element 6 slightly elastically deflecting a contact protection tab 52 and thus releasing it from the locking edge 22. The actuating element 5 may then be swiveled back into the unactuated position by manual actuation at the actuating arm 50.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A lead terminal for connecting an electrical conductor, the lead terminal comprising:
an electrically conductive core;
insulation sheathing that encloses the electrically conductive core;
a housing;
at least one insulation displacement contact at which the electrical conductor is electrically contactable, without previously stripping the insulation sheathing, via an insulation displacement operation in which the insulation sheathing is partially cut open; and
at least one swivelably supported actuating element, the electrical conductor being electrically contactable at the at least one insulation displacement contact when the actuating element is manually actuated, wherein the lead terminal further comprises one, multiple, or all of the following features a), b), c):
a) the actuating element being fixable to a component of the lead terminal, at least in an actuated position in which the electrical conductor is connected to the insulation displacement contact, the lead terminal having at least one unlocking element via which the fixing of the actuating element in the actuated position is adapted to be released;
b) at least one contact protection tab is present at the actuating element, via which an electrically conductive contact insert situated in the housing of the lead terminal and/or the at least one insulation displacement contact are/is covered in the actuated and/or unactuated position of the manual actuating element; and/or
c) the lead terminal has at least one display element, via which a sufficient actuation of the actuating element into the actuated position, in which the electrical conductor is connected to at least one insulation displacement contact, is displayable.

2. The lead terminal according to claim 1, wherein the display element is designed as a purely mechanical component that is movable via the manual actuating element.

3. The lead terminal according to claim 1, wherein the display element is part of a contact protection tab of the actuating element.

4. The lead terminal according to claim 1, wherein the at least one insulation displacement contact is fixed relative to the housing of the lead terminal.

5. The lead terminal according to claim 1, wherein the actuating element is designed as a swivelable actuating lever that is swivelable about a stationary or mobile rotational axis.

6. The lead terminal according to claim 1, wherein the actuating element has an actuating arm that protrudes from the housing of the lead terminal, via which the actuating element is manually movable into the actuated position without a tool.

7. The lead terminal according to claim 1, wherein a contact protection tab is arranged at the actuating element, on one side or on each of two sides facing away from one another, by forming it as one piece with the actuating element.

8. The lead terminal according to claim 1, wherein the at least one insulation displacement contact has at least two legs, between which a V-shaped cutting slot is provided with mutually opposite cutting edges.

9. The lead terminal according to claim 1, wherein the at least one unlocking element is arranged on a side of the actuating element facing away from the insulation displacement contact.

10. The lead terminal according to claim 1, wherein the at least one unlocking element is arranged in an unlocking shaft of the housing.

11. The lead terminal according to claim 1, wherein the actuating element has a hollow channel through which the electrical conductor, at least in the unactuated position of the actuating element, is insertable into the housing of the lead terminal.

12. The lead terminal according to claim 1, wherein a pressing surface is provided at the actuating element, via which the electrical conductor is pressable against the at least one insulation displacement contact and electrically contactable thereto when the actuating element is manually actuated into the actuated position.

13. The lead terminal according to claim 12, wherein the pressing surface is provided at an inner side of a wall of the actuating element that surrounds the hollow channel.
